(19) United States
(12) Patent Application Publication
(10) Pub. No.: US 2005/0177662 A1
(43) Pub. Date: Aug. 11, 2005

(54) Modular broadcast television products

(76) Inventors: Michael Thomas Hauke, Nevada City, CA (US); Steven Edwin Miller, Nevada City, CA (US); Raymond Andrew Bryars, Nevada City, CA (US)

Correspondence Address: Joseph S Tripoli;Thomson Licensing Inc, P O Box 5312, Princeton, NJ, 08543-5312, US

(21) Appl. No.: 10/509,969

(22) PCT Filed: Apr. 3, 2003
(86) PCT No.: PCT/US03/10271

Related U.S. Application Data
(60) Provisional application No. 60/369,813, filed on Apr. 4, 2002.

(51) Int. Cl. G06F 13/00

(52) U.S. Cl. 710/104

(57) ABSTRACT

A processing apparatus for video and or audio signals comprises a first module having a controller coupled to a signal processor. The signal processor has a signal processing characteristic selected from a plurality signal processing characteristics stored in a non-volatile memory. A second module is coupled to the first module and has a specific input output signal coupling characteristic. The controller determines the input output signal coupling characteristic of the second module and in accordance therewith selects from the plurality signal processing characteristics stored in said non-volatile memory a signal processing characteristic for the signal processor.

### BACKGROUND OF THE INVENTION

This invention relates to modular products for the television and related industries.

Modular products are generally those items that help to complete the infrastructure of a facility for video and/or audio production, post-production, playout, or transmission. Such products include devices providing not only simple functions such as amplified distribution, but also a wide range of more complex functions such as format conversion, synchronization and multiplexing.

Most frequently, modular products are implemented by means of one or more circuit assemblies plugged into a mounting frame. The mounting frame is a metal enclosure that contains all the input, output, signal processing, and control electronics and is installed in a standard 19″ equipment rack, such a frame being capable of accepting modules with a variety of functions, according to the needs of the user. The size of a frame is usually described in terms of its height measured in RU (rack unit), where 1 RU is 1 3/4 inches. The input, output and control interface connectors are located on the rear panel of the frame. Generally, the modules of one manufacturer will not plug into a frame from another manufacturer, so flexibility for the user depends on choosing a manufacturer that offers a wide range of functions.

Modular products do not generally provide the principal functions or operations of a facility; rather, they are used to help join together the major functional elements and to complete the detailed interconnection of these elements. They are essential elements of a facility, but supplemental to its main purpose. Users, therefore, seek modular products that use the minimum possible space and power.

Recent advances in available technology for processing signals, particularly digital signals, make it increasingly simple to fit many functional elements in a small space. However, two factors make it difficult to take full advantage of these advances.

First, when it is possible to create very dense functional circuitry, connector density becomes the factor limiting how much functionality can be offered in a given space. Standard cables and connectors are commonplace in most industries. As an example, most video connection in a facility is over coaxial cable, and usually such cables are terminated with BNC connectors. Only about 34 BNC connectors can fit on the rear panel of a 1 RU frame. Similar restrictions apply to other frame sizes, and to other types of connectors or mixtures of connector types. It is not helpful, for example, to provide functionality in a single rack unit that needs 50 video cable connections because this number of connections cannot be provided in the available space.

Second, the more functionality that can be built on a circuit assembly, the more possible combinations of such functionality may be required by a user, and the greater variety of circuit and connector configurations needed to enable such functionality. Generally it is not economically practical for a manufacturer to produce, or a user to acquire, many different products that differ only slightly in their functional configuration.

Two approaches have been used to address these issues. In one approach Leitch Technology Corporation of Toronto, Canada, employs a single-rack unit module, capable of a wide variety of functions and configurations. However, this flexibility is achieved in part by the provision of many different types of connector. The user chooses the required functionality, and then uses the subset of connectors appropriate to that specific functionality. The circuit modules use only a part of the available frame space; functional density is determined by the connectors provided, and in most practical applications many of these connectors are unused.

A second approach uses a mid-plane in the frame that permits modules to be inserted from both front and rear, with the ability to provide signal and control paths among rear modules, among front modules, and between front and rear modules. A range of connector/processor modules is available that plug into the rear of a frame. These modules are chosen according to the connectors and signal types (input and/or output) required, and convert signals to or from one of a small number of core formats that are used to convey the signals to the function modules, which are plugged into the front of the frame. An example of this architecture is found in the “DigiBus®” system manufactured by the Leitch Technology Corporation.

There are several disadvantages to this approach. Because of the need for a small number of signal formats on the mid-plane, the rear modules perform format conversion and thus require active electronic circuitry. This is not desirable because such circuitry can fail, and repair is possible only by replacing the failed module from the rear of the frame, which may be rendered difficult by equipment rack installation and cabling placement. The aforementioned requirement for high density requires that practical installations have a very high density of cables at the rear of modular equipment frames. It can be physically very difficult to make room to remove a module, and frequently this necessitates disconnecting multiple cables, many of which are not associated with the failed module. Such service intervention can have the effect of interrupting signal paths other than the one that has failed. Hence a single failure may result in loss of multiple unrelated signal paths. This severely impacts the practical reliability of an installation. Also, the need for a small number of permissible formats on the mid-plane may mean that otherwise unnecessary format conversions are performed, increasing both cost and signal degradation whilst decreasing reliability.

Another disadvantage to this approach is that the provision of multiple functions in multiple configuration is not simple. It is possible to manufacture a very large number of modules, so that each required combination of function and configuration is provided by a different module type. In general this is not practical or cost effective for either manufacturer or user. One practical alternative is demonstrated by the “DigiBus®” system referenced above. In this case each front module performs a relatively simple function or set of functions, and complex operations are performed by using several different front modules, interconnected via the mid-plane. Selecting an appropriate set of function modules, in combination with the one or more rear modules for input, output, and format conversion, allows the provision of many functional configurations from a reasonable number of manufactured modules. However, this approach means that in a typical application, several front modules, as well as one or more rear modules, are required to provide a functional configuration that the user will regard as a single product. This means that optimal density cannot be achieved; many products will occupy several of the limited number of slots in the apparatus frame.

Yet another disadvantage is that setup of the device requires determination of connection, direction of connection and selection of signals over the mid-plane. This can be a complex and non-intuitive process, making it more difficult for the user to benefit from the apparent flexibility of the system.

What is needed is a system of modular products that combines greater flexibility, improved functional density together with simple user configuration.

The first element of such a system is an appropriate architecture for the frame. One suitable architecture is described in co-pending patent application Ser. No. 09/551,747 filed Apr. 20, 2000. Further benefit may be obtained by the use of connector assemblies and related circuitry that permit a connector to be used in more than one way. Examples of such enhancements are found in U.S. Pat. No. 6,256,686 B1 (Bi-Directional Serial Video Port) and co-pending patent application Ser. No. 10/062,076 titled CONFIGUREURABLE AES INTERFACE.

### SUMMARY OF THE INVENTION

In an inventive arrangement multiple processing functions resident within the modular apparatus are controllably selected in accordance with the physical choice of back connector panel.

In another inventive arrangement multiple processing functions resident within the modular apparatus are controllably selected in accordance with the physical choice of sub modules located within the modular apparatus.

In a further inventive arrangement control data for facilitating selectable resident processing functions and input output configuration are stored within a non-volatile memory.

In yet a further inventive arrangement new processing functions and or configuration can be acquired remotely and stored within a non-volatile memory.

In another inventive arrangement automatic sensing is provided to facilitate input signals having either analog or digital signal formats. In addition this advantageous arrangement provides selectable analog or digital output signal configuration which permits use of the equipment in systems with analog signal formats, in systems with digital signal formats or in systems transitioning between analog and digital signal formats. In this way the inventive arrangement allows the transparent operation of the unit without user regard to the nature of the input or output signal formats.

### BRIEF DESCRIPTION OF THE DRAWINGS

FIGS. 1A, 1B and 1C illustrate respective front and rear and mid modules of a modular product employing various inventive arrangements.

FIG. 2 is a block diagram showing a functional core of a front module shown in FIG. 1A.

FIGS. 3A-3C illustrate respective connector configurations for rear modules as shown in FIG. 1B.

FIG. 4 illustrates functional and control connectivity via the mid positioned motherboard and a plurality of front and rear modules as shown FIGS. 1A, 1B and 1C.

### DETAILED DESCRIPTION

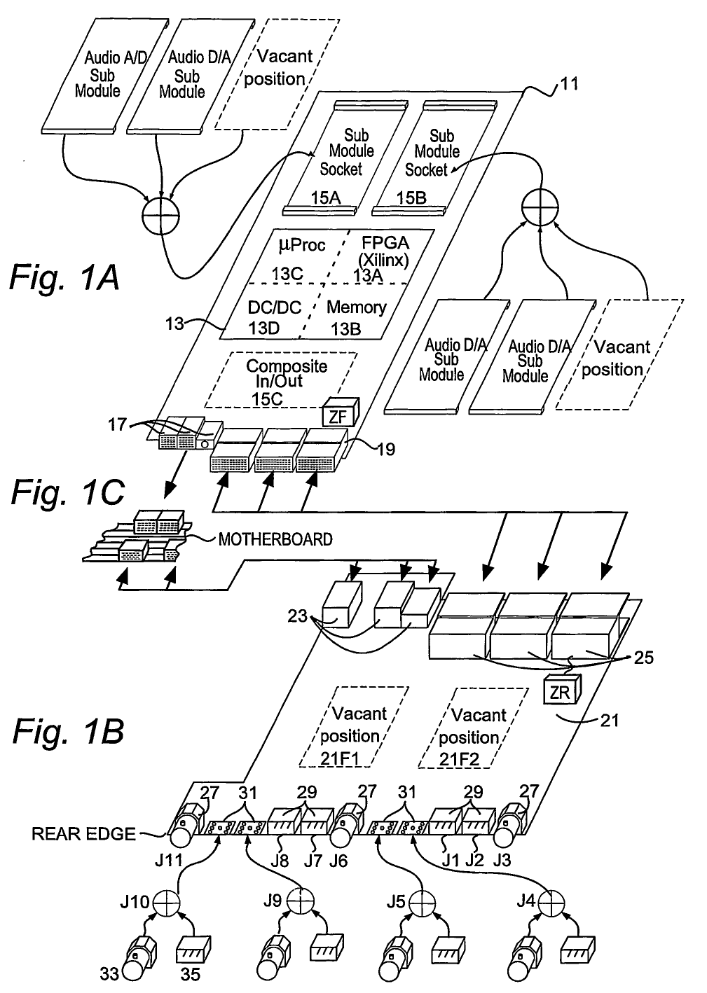

FIGS. 1A and 1B illustrate the general configuration of respective front and rear modules that are installed in a modular product chassis having a midplane motherboard, partially shown in FIG. 1C and described in patent application Ser. No. 09/551,747.

The arrangement depicted in FIGS. 1A and 1B illustrates a first inventive concept where a first or front module, is generally capable of generating all output signal forms and formats. However, the actual output signals selection is determined by the user's choice of rear or back connector module. In this way a common or standard front module can be fabricated, tested and inventoried with user specific I/O requirements satisfied with a rear or second module containing, for example, only passive connector elements.

An exemplary front module includes a circuit board 11 having a functional core 13 including, for example a field programmable gate array (FPGA) 13A, memory 13B, for example flash, SDRAM and EE PROM, a microcontroller 13C, power supply 13D. Optional processing circuit functions can be installed in areas designated 15, for example FIG. 1A shows areas 15A or 15B equipped with an audio analog to digital converter (A/D) submodule and an audio digital to analog converter (D/A) submodule. Similarly area 15C can locate a composite video input output (I/O) submodule. At a rear edge of circuit board 11 socket 17 facilitates coupling with the motherboard, and socket 19, which bypasses the motherboard and provides direct connection with the rear module. For practical reasons, sockets 17 and 19 may be implemented using two or more distinct sockets, but whether the socket 17 or the socket 19 is implemented using one socket or more sockets is not relevant to the invention and accordingly the motherboard connector and sockets 17 and 19 will be referred to in the singular.

Certain pins of the socket 19 are assigned as video signal conductors with other pins assigned for audio signals, utilities and management signals. Specifically, one pin is assigned as a video signal input, a second pin is assigned as a composite video signal out and a third pin is assigned as a serial digital interface or SDI video out. At least 16 pins are assigned to audio signal input output (I/O). Correspondingly, some pins of socket 17 are assigned to power supply and ground, with others assigned to control and communication with other front modules and with adjacent rear modules.

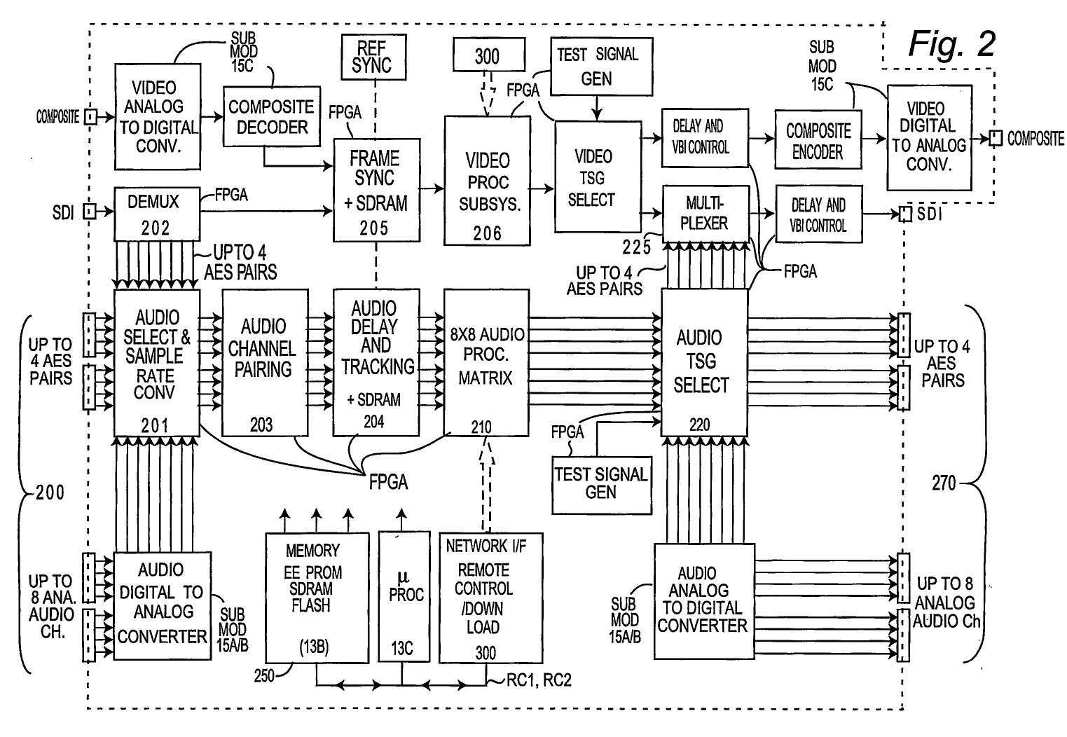

The functional core depicted in FIG. 1A, is shown in greater detail in by the functional block diagram of FIG. 2. The block diagram also includes functional blocks, for example network interface 300, and reference synchronizing signal source REF SYNC, which although not part of module 11 operate in conjunction with the module 11 and reside at other unshown module locations within the product chassis. FIG. 2 depicts a single field programmable gate array (FPGA) however one or more FPGAs can be employed to provide the various configurable processing functions shown as individual blocks. A micro-controller 13C is shown coupled to memory block 250 (13B) to provide, amongst other things, automatic product configuration. Controller 13C is also coupled to the network interface 300 to facilitate remote control and remote product upgrade. A non-volatile memory, forming part of block 250 (13B), stores programs which define functions that are selectably activated and implemented by configurable circuit arrangements of the FPGA. Although one or more FPGAs can be utilized, the number actually employed is not relevant to the invention and hence will be referred to in the singular.

The functional block diagram of FIG. 2 shows an exemplary configuration that includes an audio input selector 201 which can select up to eight Audio Engineering Society or AES audio data streams (in pairs) from up to 32 digital audio channels. The selected audio data streams can be paired in a controllable channel pairing arrangement 203 to provide, for example, music and effects, or mix minus audio feeds. The audio processor 210 provides various processing operations on the selected data streams, and audio output selector 220 receives the data streams from processor 210 and directs the streams to selected destinations. An SDI video input signal is coupled to demultiplexer 202 with an output coupled to frame synchronizer 205 for selectively delaying the video signal content of the SDI stream to preserve video to audio synchronization or lip sync. A video processor 206 provides various processing operations on the video signal, and a multiplexer 225 assembles respective signals to form an output SDI signal.

In a first exemplary configuration of core 13, the FPGA is arranged as an audio embedder where demultiplexer 202 is disabled and passes the SDI video input signal to multiplexer 225 by way of the frame synchronizer 205 and the video processor 206. The audio input selector 201 selects one or more of the audio inputs 200 and supplies these data streams to the audio output selector 220 by way of the audio processor 210. The audio output selector 220 directs the selected AES data streams to the multiplexer 225, which embeds the audio data in the horizontal ancillary data space of the SDI video signal to form an SDI output signal with embedded audio data.

In a further exemplary configuration the FPGA of core 13 is programmed to operate as a disembedder where multiplexer 202 removes the audio data from the horizontal ancillary data space of the input SDI video signal and supplies up to eight AES data streams to the audio input selector 201. Input selector 201 selects one or more of the AES data streams and supplies the selected data streams to the AES outputs 270 by way of audio processor 210 and audio output selector 220. The SDI video signal, which may, but need not, have the original AES data embedded therein, is supplied to the SDI output by way of frame synchronizer 205, video processor 206 and multiplexer 225.

In an further advantageous arrangement, core 13 can be configured to concurrently provide both disembedding and embedding functions, where audio data from the horizontal ancillary data space of the SDI input signal is disembedded by demultiplexer 201 with the disembedded audio data supplied for example to the AES output 270. Input AES audio data received from one or more of the inputs 200 is embedded in the now vacant horizontal ancillary data space of the same SDI signal by multiplexer 225. Thus, this advantageous arrangement facilitates a process known as single pass or on the fly modification of audio programming embedded in an SDI stream, also known as a read-modify-write operation.

Programming or configuration arrangements for one or more FPGAs can be stored in a nonvolatile memory such that the FPGA is controllably able to perform, for example, a reduced set of processing functions or to provide different processing functions of greater complexity and greater acquisition cost. For example, although the arrangement of blocks shown in FIG. 2 is selected to enable the FPGA to perform the functions associated with embedding and/or disembedding audio data, the embedding and disembedding functions may be disabled to allow the FPGA to be operated as, for example, an audio processor, to provide the functions of audio A/D, audio D/A, or as a video processor, time base corrector or sync generator.

Remote digital commands can be input via the network interface 300 to controller 13C which in turn communicates within core 13 to access the EE PROM memory forming part of 250 (13B). In this way the FPGA functions can be changed, programmed or reprogrammed by recalling from memory either different factory installed settings or newly down-loaded and stored parameters to alter the functionality of the core. The functionality of the core may not necessarily be changed by the user but rather the user may download or otherwise obtain a configuration program which allows the controller to either update existing functionality of the core or to reconfigure functionality to provide new processing capabilities.

In simple terms, the advantageous combination of an FPGA delivered with various levels of processing functionality or sophistication, together with a memory containing the corresponding FPGA functionality configurations, allows the manufacturer to assemble products with a standard FPGA and accompanying standard functionality memory. In this way manufacturing costs are minimized yet individual user requirements are satisfied. For example, a finished good inventory can contain standardized products which are customized during final test prior to customer shipment. Advantageously the standardized product contains all product features and facilities, however, customer or cost specific functionality is determined by the manufacturer. The customer's product features and facilities are provided by arranging, or programming the product memory to allow only the purchased functionality to be accessed and loaded each time the device is powered up. The advantageous use of a memory containing a set of standardized features and facilities endows the product with an ability to be reconfigured, furthermore the provision of networked control capability allows the remote control of product functionality, diagnostic maintenance or product upgrading. Hence a cost effective entry Level front module can be provided with a first level of processing functionality but with the installed capability for subsequent upgrading to higher levels of functionality, without any requirement for module removal or replacement.

It will be apparent from the foregoing discussion that the front module shown in FIG. 1A can have many different combinations of inputs and outputs. For example, the front module can accept an SDI video input signal via BNC J11 and connector 19 and provide an SDI video output signal at the SDI video out BNC J1. If the composite video I/O submodule is mounted at area 15C, the module can be configured to accept a composite analog video input signal and to provide a composite analog video output signal at the composite video out pin. The composite video I/O submodule digitizes the composite video input signal received via connector 19 and decodes the composite video to component form for delivery to core 13. On the output side, the composite video I/O submodule of area 15C receives component digital video from core 13, encodes the component video to composite form and converts the digital composite video signal to an analog composite video output signal. The front module, depending on its configuration, can also accept and output analog audio and/or AES data streams.

FIG. 1B illustrates a rear module comprising circuit board 21 with connector 23 for coupling with the motherboard, partially shown in FIG. 1C, and connector 25 for directly coupling with connector 19 of the front module. For practical reasons, connector 23 may be implemented by two or more separate sockets but this implementation aspect is not relevant to the invention and accordingly motherboard connector 23 is referred to in the singular. Similarly, connector 25 is referred to in the singular.

The outer edge of circuit board 21 has 11 connector locations. Three of these connector Locations are occupied by BNC connectors 27, four Locate terminal block connectors 29 suitable for accepting a plug of the type conventionally used on twisted pair cable, for example manufactured by Phoenix Contact Corporation under the designation COMBICON, with the remaining four locations 31 left vacant. Each BNC connector 27 has a central signal conductor and an outer ground conductor. Each terminal block connector 29 has two balanced signal conductors and a ground conductor. A BNC connector can be used for input or output of composite video or serial digital video or for input or output of AES audio in unbalanced form. A terminal block connector can be used for input or output of analog audio or for input or output of AES audio in balanced form.

Circuit board 21 includes a ground conductor layer and one or more signal conductor layers containing signal traces. The ground conductor layer is connected to ground through connector 23 and the motherboard, which includes a ground rail connected to a power supply incorporated in the mounting frame. Each of the signal traces is connected to one or more pins of socket 23 and/or one or more pins of plug 25. The ground conductors of the connectors 27 and 29 are connected to the ground conductor of the circuit board 21 and the signal conductors of the connectors 27 and 29 are connected to respective signal traces of the circuit board 21.

At each of the vacant connector locations 31 there is a pattern of contact pads including at least one pad connected to the ground conductor of the circuit board 21 and at least two pads connected to signal traces. The pattern of pads is such that connections can be made to either a BNC connector 33 or a terminal block connector 35. Thus, depending on the mix of BNC connectors 33 and terminal block connectors 35, the circuit board 21, may have as few as three and as many as seven BNC connectors and as few as four and as many as eight terminal block connectors.

The eleven connectors of the rear module are designated J1-J11 respectively. In a preferred embodiment of the invention, the connectors J1, J6 and J11 provide video connection with the other eight connectors providing audio connection. Connector J1 is assigned to serial digital video out, with BNC connector J6 providing composite video out and BNC connector J11 to serial digital video in or composite video in. The signal traces of the circuit board 21 connect the center conductors of the connectors J1, J6 and J11 to the pins of the plug 25 that engage, respectively, the SDI video out pin, the composite video out pin and the video in pin of the socket 19. The connectors J2, J3, J7 and J8 are terminal block connectors for audio I/O but they are not assigned in advance to analog audio or AES. Each audio connector is connected to an I/O port, the components of which can be distributed between the rear module and the front module. The port is either balanced or unbalanced, depending on the nature of the connector for that port.

For each port, connector 25 provides two pins that engage corresponding pins of the connector 19. In the event that the audio connector is a terminal block connector, these pins allow a balanced signal to be supplied to or from the front module. In the event that the connector is a BNC connector, one pin allows an unbalanced signal to be supplied to or from the front module with the other pin grounded in the rear module.

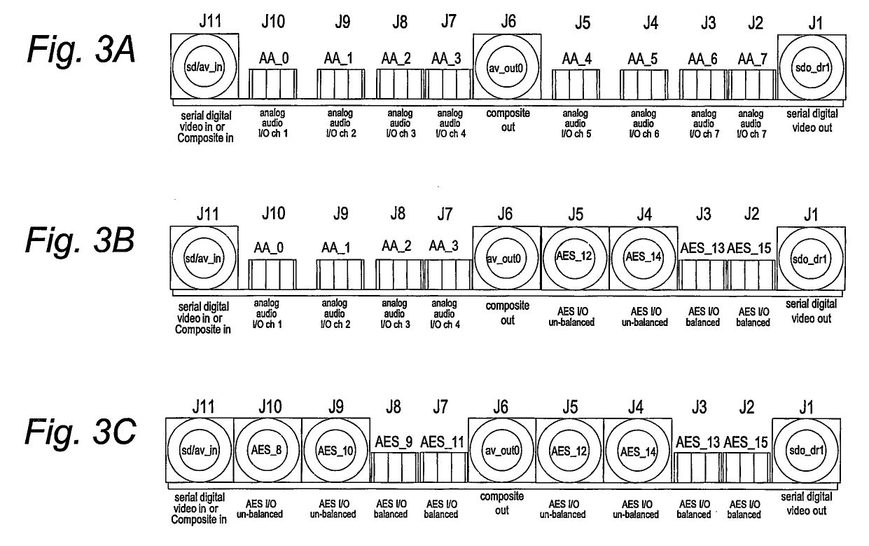

FIGS. 3A-3C show three exemplary connector combinations for the rear connectors of the rear module. Each exemplary configuration of rear module is designed for use with a front module that is configured as an audio data embedder, a disembedder or to facilitate simultaneous disembedding and reembedding in an SDI stream.

In the first connector combination, shown in FIG. 3A, all eight audio connectors are terminal block connectors and the audio ports are analog audio ports, each of which can be either an input or an output port. In this case, the audio ports connected to the audio connectors are balanced ports. This configuration of rear module is useful with a front module that is provided with an audio A/D submodule 15A and an audio D/A submodule 15B. Each terminal block connector supports one analog audio I/O channel. This exemplary connector combination is referred to hereinafter as the model A combination.

In a second exemplary connector combination, shown in FIG. 3B, the terminal block connectors J2 and J3 are connected to balanced AES I/O ports. The connectors J4 and J5 are BNC connectors and are connected to unbalanced AES I/O ports. The terminal block connectors J7-J10 are used for analog audio I/O channels, as described with reference to FIG. 3A. This configuration of rear module is suitable for use with a front module configured to support up to four analog I/Os, two balanced AES I/Os and two unbalanced AES I/Os. This configuration of front and rear modules requires less digital-to-analog and analog-to-digital conversion resources than does that shown in FIG. 3A. This connector combination is referred to hereinafter as the model B combination.

A third exemplary connector combination, shown in FIG. 3C, is used with a front module without audio A/D and D/A resources. The terminal block connectors J7 and J8 are used for balanced AES I/O and the connectors J9 and J10 are BNC connectors used for unbalanced AES I/O. The configuration shown in FIG. 3C is otherwise the same as that shown in FIG. 3B. This connector combination is referred to hereinafter as the model C combination.

As described previously, connector 25 of each rear module type mates directly with a corresponding connector 19 of each front module type. Assigned to each plug pair 25/19 are a number of conductors or pins which are designated as module personality pins (PERP). In a further embodiment three personality pins designated A, B and C are appropriately connected to a coding node in the second module which allows each rear module type to be uniquely identified. The coding node is connected to an appropriate logical potential, for example a positive voltage, with corresponding personality pins of connector 19 of the front module monitored by controller 13C. Thus three personality pins allow a binary representation, and detection by controller 13C of at least seven different rear module types. However, in the exemplary arrangement of FIG. 3 only three rear module types, models A, B, and C respectively are described. Thus, in the case of the module A connector combination, the personality pin A is connected to the coding node, and similarly for models B and C connector combinations. The corresponding personality pins of socket 19 are connected to controller 13C such that at power-up controller 13C determines the module type, for example by use of hard wired logic or with reference to a table, and acquires from EEPROM memory 250, (13B) and applies to FPGA 13A the processing and signal coupling configuration that is appropriate for the particular rear module connector combination.

The three exemplary connector combinations shown in FIGS. 3A-3C provide the necessary video interconnect for an embedder or disembedder and also allow a wide range of choices for audio interconnect, yet each requires only 11 connectors. Because the choice of connector combination advantageous determines the desired processing functions to be provided, unnecessary or redundant I/O connectors are obviated and physical rack space requirements for chassis installation are held to a minimum.

It will be appreciated that the three configuration of the rear connectors of the rear module are shown by way of example only and that other connector combinations may be employed, depending on the requirements of the front module. In particular, as noted previously, functions other than embedding and disembedding can be performed by suitably programming the FPGA, and these other functions may favor different connector combinations than shown in FIGS. 3A-3C.

A modular product range can provide various mounting options, for example in an exemplary arrangement, 12 front/rear module pairs may be housed in a single chassis. In such a multi module system there should be no requirement to populate all chassis locations in order to exploit the advantageous automated configuration and functionality disclosed herein. Inevitably such modular systems can permit the pairing of incompatible front and rear modules assemblies, for example modules incapable of self/remote functional configuration. Thus to obviate inoperative or spurious functionality a further embodiment advantageous utilizes a plurality of, for example 10, personality pins coupled via plug pair 25/19 to identify which chassis locations are populated and, with what type of with module.

In this further exemplary embodiment all but two of the 10 personality pins or conductors are connected to ground or reference zero potential. A first specific one of the two ungrounded conductor/pins is unconnected or open circuited at connector 25. An open circuit on a designated one of the 10 pins indicates to the front module, and controller 13C, that a compatible rear module is present. Similarly if the specific conductor/pin is determined to be grounded then the controller 13C can signal the user, via for example a visual display unit coupled to the network interface 300, that a module incompatibility exists at a specific chassis location.

If an acceptable module type is identified as present in a specific chassis location, controller 13C performs a test on the second ungrounded conductor of connector pair 25/19. The second ungrounded conductor/pin of connector 25 is advantageously connected to, for example ground, via a network Z. The network is examined by controller 13C, via the front panel connector 19 to determine the specific processing and or coupling configuration capability to be supported by the particular rear module. Network Z is coupled to form a Larger impedance with a further network Located in the front panel module. The junction node between the rear and front networks is measured with the result used by controller 13 to determine the functional processing configuration required. In a further arrangement the network. Z at connector 25 is, for example, a resistor ZR connected to ground with the corresponding pin of front panel connector 19 connected to a reference potential +ve via a second resistor ZF. Thus a potential divider is formed at the junction of resistor ZF and connector 19 having a predetermined division ratio representative of a specific rear module type. Hence the divider ratio can be determined and specific processing and functionality can be established at the chassis location of the selected front/rear module pair. A voltage formed at the junction node is measured by an analog to digital converter ADC and communicated to controller 13C where the divided voltage value is used to identify, for example using a look up table stored in memory, the specific rear module type present and connectivity and functionality required by this module selection.

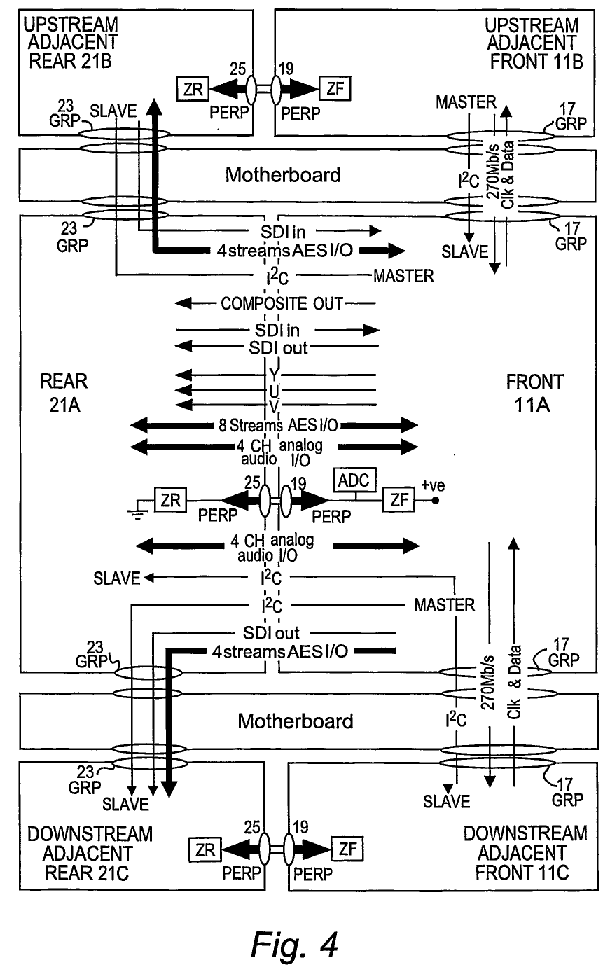

FIG. 4 illustrates functional and control connectivity between a plurality of front and rear module pairs via the motherboard, such as shown in FIGS. 1A,1B, and 1C. In FIG. 4 three exemplary front and rear modules 11A, 11B and 11C and 21A, 21B and 21C, respectively, are shown with simplified functional and control connectivity. Power for the individual modules is sourced from a chassis power supply (not shown) and provided via the motherboard to connectors 17 and 25 of each module. Coding nodes, for example network Z of the rear modules 21A, 21B and 21C are connected to the personality pins PERP of the respective sockets 19. As described previously these personality connection pins are coupled via connector 25 and engage with corresponding pins of connector 19.

In FIG. 4 the advantageous inter-module connectivity or grouping is depicted by conductors, within existing module and motherboard connectors, collectively designated GRP. These grouping or connectivity connections facilitate the sharing of video and audio signals, control data, for example using an I²C bus protocol, and clock and data signals by coupling via sockets 17, 23 and the motherboard. As described previously personality determining codes are coupled between each rear and front module pair via connection (PERP) and plug pair 25/19. Similarly adjacent rear modules are interconnected via the grouping GRP via connectors 23 of each module via the motherboard. In this way a controllable interconnection capability can be established between not only individual front and rear modules but also between adjacent individual front and or rear modules which permits a wide range of configurations to be established. It will be appreciated that this interconnection capability can be auto configuring, based on power-up module detection, or can be manually or remotely established by means of the network interface 300 and exemplary remote control signals RC1, RC2 generated by a set up or configuration control capability, provided by a remote visual display unit or computer terminal.

In a further embodiment, the functionality of a single modular product may be enhanced or reconfigured using multiple front modules, each having a companion rear module. A given front module may exercise control over operation of adjacent front modules, being connected, as described to the adjacent modules via the motherboard. A front module may not only be connected to its companion rear module by the direct connection but in addition may be connected to and exercise control of adjacent rear modules through the direct connection between adjacent rear modules via the motherboard.

In the event that a single rear module provides insufficient interconnect capability for the modular product configured using the companion front module, the front module may be associated with two or more rear modules to provide additional interconnection capacity through the motherboard connections. In this event, control may be exercised over the rear module based on stored setup from EE PROM in conjunction with both the resident controller and the companion front module.

In this exemplary modular product the mounting frame typically contains an AC power supply, a control module that communicates with the front modules via the motherboard and the connector 17 to supply user control signals to the front module, e.g. for selecting an audio port. In addition, the mounting frame or chassis may contain a network interface module 300 to provide communication between the control module and other network nodes to allow setup, control, and configuration from locations remote from the modular product.

If a exemplary modular product is considered from either a manufacturing or product acquisition cost standpoint it appears beneficial to employ a passive rear module. However, the inventive automated module personality derivation and processing configuration can be equally well applied to a rear module which can include one or more controllable circuits, for example as illustrated in blocks 21F1 and 21F2 of FIG. 1B.

1. A processing apparatus for video and or audio signals comprising:
a first module having a controller coupled to a signal processor having a signal processing characteristic selected from a plurality signal processing characteristics stored in a non-volatile memory; and,
a second module coupled to said first module and having a specific input output signal coupling characteristic,
wherein said controller determines said input output signal coupling characteristic of said second module and in accordance therewith selects from said plurality signal processing characteristics stored in said non-volatile memory a signal processing characteristic for said signal processor.

2. The apparatus of claim 1, wherein said controller determines said input output signal coupling characteristic of said second module during a power up sequence.

3. The apparatus of claim 1, wherein said second module comprises a personality pin coupled to said first module to enable detection of said input output signal coupling characteristic by said controller.

4. The apparatus of claim 1, wherein said controller determines said input output signal coupling characteristic of said second module by measurement of a coupling node.

5. The apparatus of claim 1, wherein said controller determines said input output signal coupling characteristic of said second module in accordance with a potential at a node between said first and second module.

6. The apparatus of claim 1, wherein said controller determines said input output signal coupling characteristic of said second module by measurement and comparison with a lookup table.

7. The apparatus of claim 1, wherein said second module comprises only passive electronic circuitry.

8. The apparatus of claim 1, wherein other ones of said plurality signal processing characteristics stored in said non-volatile memory correspond with other ones of said second module each having different input output signal coupling characteristics.

9. The apparatus of claim 1, wherein said second module comprises passive and active electronic circuitry.

10. The apparatus of claim 9, wherein said active electronic circuitry is functionally configurable.

11. The apparatus of claim 1, wherein said first module has an audio signal processing characteristic.

12. A processing apparatus for video and or audio signals, comprising:
a first module having a controller coupled to a memory and to a signal processor having a signal processing characteristic determined by one of a plurality of processing characteristics stored in said memory; and,
a second module having a second signal processing characteristic;
wherein said controller determines said second signal processing characteristic of said second module and retrieves from said plurality of processing characteristics stored in said memory a processing characteristic for said signal processor in accordance with said determined signal processing characteristic of said second module.

13. The apparatus of claim 12, wherein other ones of said plurality processing characteristics stored in said memory correspond with other ones of said second module each having a different signal processing characteristic.

14. The apparatus of claim 12, wherein said controller determines said signal processing characteristic of said second module by measurement of a second module identifier during a power up sequence.

15. A processing apparatus for video and or audio signals comprising:
a network interface,
a controller coupled to said network interface;
a memory coupled to said controllers; and,
a signal processor coupled to said memory, said signal processor having a signal processing characteristic determined in accordance with a characteristic stored in said memory,
where in accordance with a signal from said network interface, said controller accesses from a plurality of characteristics stored in said memory a characteristic specific to said processing apparatus.

16. The apparatus of claim 15, wherein access to ones of said stored plurality of signal processing characteristics is limited to only said specific characteristic.

17. The apparatus of claim 15, wherein said plurality of characteristics stored in said memory enable differing levels of signal processing complexity by said signal processor.

18. The apparatus of claim 15, wherein access to ones of said stored plurality of signal processing characteristics is in accordance with said processing apparatus selling price.

19. The apparatus of claim 15, where in accordance with a second signal from said network interface said controller enables unlimited access to ones of said stored plurality of signal processing characteristics.

20. The apparatus of claim 15, wherein said memory containing said plurality of signal processing characteristics is alterable in accordance with a second signal from said network interface.

21. A method for configuring a multi-function signal processing apparatus for users requiring less than all available functions, comprising the steps of:
storing a signal processing characteristic for each of said available functions; and,
enabling access to at least a predetermined one of said plurality of signal processing characteristics, all remaining ones of said plurality of signal processing characteristics being non-accessible,
subsequent to said storing and enabling steps said signal processing apparatus being operable only with said at least predetermined one of said plurality of signal processing characteristics.

22. The method of claim 21, comprising the step of:
implementing said enabling step in a field programmable gate array.

23. The method of claim 21, wherein said enabling step comprises the step of inhibiting access to all but said at least predetermined one of said plurality of signal processing characteristics.

24. The method of claim 21, wherein said enabling step comprises the step of enabling said at least predetermined one of said plurality of signal processing characteristics to be read during a power up condition of said apparatus.
